(19) United States
(12) Patent Application Publication
(10) Pub. No.: US 2024/0351426 A1
(43) Pub. Date: Oct. 24, 2024

(54) DRIVE SYSTEM AND VEHICLE WITH A DRIVE SYSTEM

(71) Applicant: IMS GEAR SE & CO. KGAA, Donaueschingen (DE)

(72) Inventors: Michael GOETZ, Konstanz (DE); Sebastian BREITHAUPT, Marbach (DE); Johannes STOEHR, Villingen-Schwenningen (DE); Yvonne FUERDERER, Furtwangen (DE)

(21) Appl. No.: 18/637,884

(22) Filed: Apr. 17, 2024

(30) Foreign Application Priority Data
Apr. 21, 2023 (EP) 23169233.6

(51) Int. Cl. B60K 7/00; B60K 17/04; B60T 1/06

(52) U.S. Cl. CPC B60K 7/0007; B60K 17/043; B60T 1/062; B60K 2007/0092

(57) ABSTRACT

A drive system (10), in particular for a vehicle, comprising
a driven unit (12),
a drive unit (18) for driving the driven unit (12),
a drive interface (20) by means of which the driven unit (12) can be coupled to the drive unit (18),
at least one brake unit (22) for braking the driven unit (12), and
at least one brake interface (24) which is different from the drive interface (20) and by means of which the driven unit (12) can be coupled to the at least one brake unit (22),
wherein the at least one brake interface (24) has a transmission stage (28) with a driven-side transmission component (30) arranged on the driven unit (12) and a brake-side transmission component (32) arranged on the at least one brake unit (22),
and
a vehicle, in particular an industrial truck, with a drive system (10) of this kind.

The invention relates to a drive system and a vehicle with a drive system of this kind.

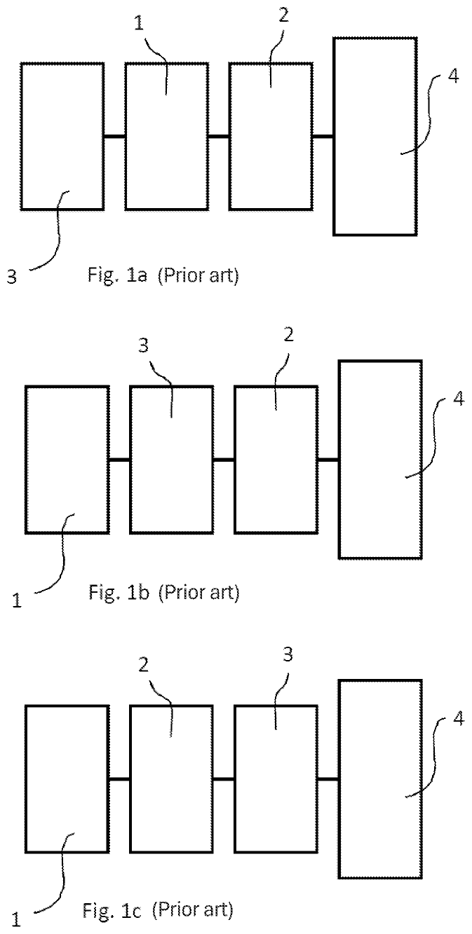

Various concepts of drive systems for vehicles, such as industrial trucks in particular, known from the prior art, are shown in FIGS. 1a to 1c. They generally comprise a motor 1, which is often an electric motor, a drive transmission 2, at least one brake 3, and an impeller 4 of the vehicle. In the power flow direction of the driving torque provided by the motor 1, the drive transmission 2 is arranged downstream of the motor 1 and the impeller 4 downstream of the drive transmission 2, so that the motor 1 can drive the impeller 4 by means of the drive transmission 2. Various concepts are known from prior art for arranging the brake 3. In previously known drive systems, the brake 3 is arranged upstream of the motor 1 (FIG. 1a), between the motor 1 and the drive transmission 2 (FIG. 1b) or between the drive transmission 2 and the impeller 4 (FIG. 1c).

In the examples shown in FIGS. 1a and 1b, the braking torque provided by the brake 3 is converted by the generally reducing drive transmission 2, so that the braking torque provided by the brake 3 is smaller than the braking torque applied to the impeller 4. However, in these cases, the drive transmission 2 is in the power flow from the brake 3 to the impeller 4 and thus in what is referred to as the safety line, a safety-relevant section of the drive system. If the drive transmission 2 fails, the brake 3 can no longer act on the impeller 4. The drive transmission 2—and in the case shown in FIG. 1a also the corresponding components of the motor 1—must therefore be dimensioned with a correspondingly high safety factor.

If, instead, as shown in FIG. 1c, the brake 3 is arranged between the drive transmission 2 and the impeller 4, for example directly on the impeller 4 to be braked, the brake 3 must have larger dimensions in accordance with the lack of reduction through the drive transmission 2.

The known drive systems therefore have disadvantageous properties with regard to their installation space requirements and/or their mass, particularly in the region of the drive transmission or the brake.

The object of the invention is therefore to provide a drive system that has a small space requirement and a low mass and is easy to manufacture. The object of the invention is to provide a vehicle with a drive system of this kind.

The object is achieved according to the invention by a drive system having the features of claim 1 and a vehicle having the features of claim 15.

Advantageous embodiments and developments of the invention are specified in the dependent claims.

A drive system according to the invention, in particular for a vehicle, comprises a driven unit, a drive unit for driving the driven unit, a drive interface by means of which the driven unit can be coupled to the drive unit, at least one brake unit for braking the driven unit, and at least one brake interface which is different from the drive interface and by means of which the driven unit can be coupled to the at least one brake unit, wherein the at least one brake interface has a transmission stage with a driven-side transmission component arranged on the driven unit and a brake-side transmission component arranged on the at least one brake unit. In particular with regard to the flow of force in the drive system, the brake unit is therefore arranged preferably parallel to the drive unit. With such a structure, the safety line can be made as short as possible. In particular, the drive system can be designed in such a way that the drive unit is not integrated into the safety line. The drive unit can therefore be made smaller and lighter. In addition, the arrangement according to the invention allows the torque between the brake unit and the driven unit to be reduced. This means that the brake can also be designed to be correspondingly small and light. The drive system according to the invention can therefore be made smaller and lighter on the whole.

The drive unit preferably comprises a motor, in particular an electric motor, and a drive transmission that is different from the transmission stage of the at least one brake interface. The transmission stage of the at least one brake interface is preferably a gear pair. The number of the at least one brake interface preferably corresponds to the number of the at least one brake unit. Particularly preferably, each of the at least one brake unit is assigned to exactly one of the at least one brake interface.

Preferably, each of the at least one brake interface has exactly one transmission stage. If the transmission stage is a gear pair, the at least one transmission stage therefore has exactly one gear pair, i.e. two gears that can be brought into engagement with one another. This means that the at least one brake interface can be designed with a small number of components and is therefore advantageous, particularly with regard to the mass and the required installation space.

The driven-side transmission component can be an internally toothed ring gear. A driven-side transmission component of this kind can be arranged on the driven unit in a particularly space-saving manner and thus allow for a large reduction ratio. In addition, the driven-side transmission component, which is an internally toothed ring gear, can easily be coupled to a plurality of brake-side transmission components, depending on the application.

The brake-side transmission component can be an externally toothed pinion. The pinion can therefore be a spur gear. The pinion is preferably in engagement with the ring gear. The axles of the ring gear and the pinion are particularly preferably arranged parallel to one another.

The pinion is preferably arranged on a brake shaft of the brake unit. This means the safety line can be kept as short as possible. The toothing of the pinion is particularly preferably integrated into the brake shaft. In this way, the number of components in the safety strand can be further reduced.

According to a preferred embodiment of the invention, a drive-side component of the drive interface is arranged, preferably directly, on the drive unit and/or a driven-side component of the drive interface is arranged, preferably directly, on the driven unit.

The driven unit is preferably a wheel, in particular an impeller. The driven unit is therefore preferably the unit that produces a mechanical interaction with the device superordinate to the drive system, such as a vehicle, with an environment. The safety strand can therefore be designed to be particularly short and have few components. The wheel can have two opposing wheel end faces, an inner wheel surface, and an outer wheel surface. The driven-side transmission component can be arranged in particular on one of the wheel end faces and/or on the inner wheel surface and/or on the outer wheel surface. The ring gear is preferably arranged on the inner wheel surface. The brake-side transmission component, in particular the pinion, can thus be arranged to engage axially in the contour of the wheel when engaging with the ring gear. This allows the axial installation space of the drive system to be shortened. Here and below, the term impeller is preferably understood to mean a wheel of a vehicle that establishes contact between the vehicle and the environment relative to which the vehicle can be moved. The impeller can substantially serve to transmit the vehicle forces, in particular braking, acceleration, and/or lateral forces, to the environment, in particular a roadway.

In a preferred embodiment of the invention, the wheel comprises a preferably funnel-shaped wheel carrier, which comprises a first wheel carrier part and a second wheel carrier part, the driven-side transmission component being arranged on the second wheel carrier part. The wheel carrier can comprise at least one cylindrical section. Alternatively, the wheel carrier can be completely cylindrical. The second wheel carrier part preferably comprises the portion of the funnel-shaped wheel carrier that has the largest inner diameter. As a result, the brake-side transmission component can be coupled particularly well with the driven-side transmission component. In particular, if the driven-side transmission component is a ring gear, a particularly large reduction ratio can be achieved.

In one embodiment of the invention, the second wheel carrier part is detachably arranged on the first wheel carrier part. Here and in the following, “detachable” is preferably understood to mean “non-destructively detachable”. This means that the second wheel carrier part, and thus also the driven-side transmission component, can be particularly easily replaced. In particular, wear on the driven-side transmission component or changed requirements of the driven-side transmission component can thus be responded to relatively easily and with little expenditure of costs and resources.

In an alternative embodiment of the invention, the wheel carrier is designed as a single piece. This allows the drive system to be further optimized in terms of installation space and mass.

The first wheel carrier part can have a driven-side component of the drive interface. The driven-side component can comprise in particular a coupling option for coupling the drive unit to the driven unit. The coupling option can comprise, for example, one or more bores for coupling a transmission output of the drive transmission of the drive unit to the first wheel carrier part.

Preferably, the wheel carrier is coupled in a rotationally fixed manner to a wheel rim which is arranged radially outside the wheel carrier. This allows the wheel rim to be replaced without having to replace the brake interface and/or the drive interface. The wheel carrier is particularly preferably arranged directly adjacent to the wheel rim.

In a preferred embodiment of the invention, the drive unit is at least partially, preferably completely, arranged in the wheel carrier. As a result, the drive system can have a particularly small installation space requirement. The drive unit is particularly preferably arranged completely in the wheel carrier.

The brake unit is preferably a spring-loaded brake with a first friction partner and a second friction partner, the first friction partner being arranged in a rotationally fixed manner on a brake shaft of the brake unit. The brake unit preferably has exactly one brake shaft. The pinion and the first friction partner are therefore preferably arranged on the same brake shaft. This means that a particularly compact design of the drive system comprising a small number of parts can be achieved. The second friction partner can be arranged in a fixed manner, for example by being coupled to a frame component of the vehicle comprising the drive system. During a braking process, the first friction partner and the second friction partner are preferably pressed axially against one another and are thus brought into frictional contact. For this purpose, the first friction partner can be arranged so as to be axially movable relative to the brake shaft. Preferably, the brake unit is designed such that it is closed in the unactuated state. By energizing the brake unit, the drive system can be brought into an unbraked state. With such a structure, the drive system can be automatically put into a braked and therefore safe state, particularly in the event of a power failure.

Alternatively, the at least one brake unit can be formed by a brake of any known brake type, for example by a magnetic brake.

In a further development of the invention, the at least one brake unit comprises a plurality of brake units and the drive system has a corresponding number of brake interfaces. Preferably, there is exactly one brake interface for each of the brake units. Particularly preferably, the at least one brake unit comprises exactly two brake units. In this case, the drive system preferably has exactly two brake interfaces. This means that redundancy can be achieved with regard to the brake units and thus a higher level of safety can be achieved. In addition, the two brake units can work together during the braking process and thus replace a larger brake unit. This results in additional design options with regard to the installation space required by the drive unit.

The brake-side transmission component of each of the brake units can preferably be coupled to the same driven-side transmission component. The two brake interfaces can therefore comprise different brake-side transmission components but the same driven-side transmission component. This allows several brake units to be easily coupled to one driven unit. If the brake-side transmission component is a pinion and the driven-side transmission component is a ring gear, the pinions of a plurality of brake units, in particular two, can, for example, be in engagement with the same ring gear.

A vehicle according to the invention comprises a previously described drive system. The vehicle can be an industrial truck, in particular a forklift or driverless transport system.

As is usual with industrial trucks, the vehicle preferably includes three different braking systems, namely a service brake, a holding brake, and an emergency brake. Preferably, in particular exclusively, the emergency brake is formed by the previously described at least one brake unit of the drive system.

An exemplary embodiment of the invention is explained with reference to the following Figures, In the drawings:

FIG. 1a shows a representation of a first principle of a drive system known from prior art;

FIG. 1b shows a representation of a second principle of a drive system known from prior art;

FIG. 1c shows a representation of a third principle of a drive system known from prior art;

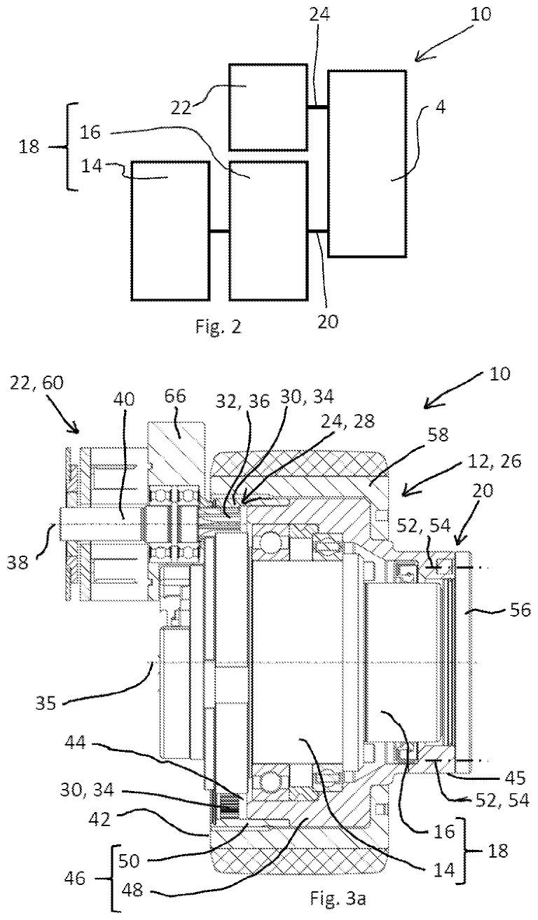

FIG. 2 shows a representation of a principle of a drive system according to the invention;

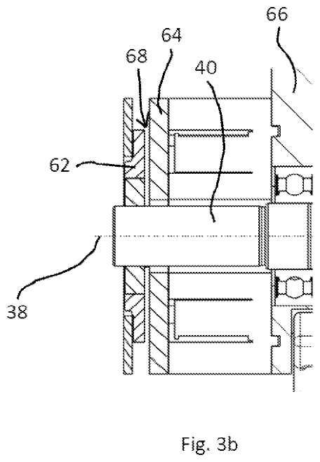

FIG. 3a is a sectional view of an exemplary embodiment of a drive system according to the invention; and

FIG. 3b is a detailed view of part of the brake unit of the exemplary embodiment shown in FIG. 3a.

FIGS. 2 to 3b show a schematic diagram and various views of an exemplary embodiment. The same reference numbers are used for the same and functionally identical parts. For the sake of clarity, not all reference numbers are used in every Figure.

FIG. 2 shows a schematic diagram of a drive system 10 according to the invention comprising a driven unit 12 and a drive unit 18, comprising an electric motor 14 and a drive transmission 16, for driving the driven unit 12. The driven unit 12 can be coupled to the drive unit 18 by means of a drive interface 20. The drive system 10 also comprises at least one brake unit 22 for braking the driven unit 12, and at least one brake interface 24 which is different from the drive interface 20 and by means of which the driven unit 12 can be coupled to the at least one brake unit 22. With regard to the power flow in the drive system 10, the brake unit 22 is preferably arranged parallel to the drive unit 18.

FIG. 3a shows a structural design of the drive system 10 using an exemplary embodiment. The drive unit 18 comprising the electric motor 14 and the drive transmission 16 and the brake unit 22 can also be seen here. The driven unit 12 is preferably an impeller 26 of an industrial truck. The brake interface 24 has exactly one transmission stage 28 comprising a driven-side transmission component 30 arranged on the driven unit 12 and a brake-side transmission component 32 arranged on the brake unit 22. In the sectional view in FIG. 3a, it can be seen that the transmission stage 28 of the brake interface 24 is completely independent of the drive transmission 16 of the drive unit 18. From both the schematic diagram in FIG. 2 and the exemplary embodiment shown in FIG. 3a, it is clear that the safety line running from the brake unit 22 to the driven unit 12 can be made significantly shorter compared to the solutions known from prior art. In particular, the drive unit 18 is not integrated into the safety line.

In the exemplary embodiment shown in FIG. 3a, the driven-side transmission component 30 is an internally toothed ring gear 34 with a ring gear axle 35. The brake-side transmission component 32 is an externally toothed pinion 36 with an axle pinion axle 38. The pinion 36 is in engagement with the ring gear. The ring gear axle 35 and the pinion axle 38 are arranged parallel to one another. The pinion 36 is arranged on a brake shaft 40 of the brake unit 22 by integrating the teeth of the pinion 36 into the brake shaft 40.

The impeller 26 can have two wheel end faces 42 facing one another, an inner wheel surface 44, and an outer wheel surface 45. The driven-side transmission component 30 can be arranged on one of the wheel end faces 42 and/or on the inner wheel surface 44 and/or on the outer wheel surface 45. In the exemplary embodiment shown in FIG. 3a, the driven-side transmission component 30, designed as a ring gear 34, is arranged on the inner wheel surface 44. The pinion 36 is thus arranged so as to engage axially in the contour of the impeller 26 when it engages with the ring gear 34. As a result, in particular the axial installation space of the drive system 10 can be shortened.

The impeller 26 has a funnel-shaped wheel carrier 46 which comprises a first wheel carrier part 48 and a second wheel carrier part 50, the ring gear 34 being arranged on the second wheel carrier part 50. The second wheel carrier part 50 comprises the section of the funnel-shaped wheel carrier 46 which has the largest inner diameter. As a result, the pinion 36 can be coupled particularly well with the ring gear 34 and a particularly large reduction ratio can be achieved with little additional space requirement. In the exemplary embodiment shown in FIG. 3a, the second wheel carrier part 50 is detachably arranged on the first wheel carrier part 48. This means that the second wheel carrier part 50 and thus also the ring gear 34 can be replaced particularly easily. In an alternative embodiment of the invention (not shown), the wheel carrier 46 is a single piece.

The first wheel carrier part 48 shown in FIG. 3a also has a driven-side component 52 of the drive interface 20. The driven-side component 52 has a plurality of bores 54 by means of which a drive transmission output 56 of the drive transmission 16 of the drive unit 18 is coupled to the first wheel carrier part 48.

The representation in FIG. 3a shows that a drive-side component of the drive interface 20 designed as a drive transmission output 56 is arranged directly on the drive unit 18 and the driven-side component 52 of the drive interface 20 is arranged directly on the driven unit 12, namely the impeller 26.

The wheel carrier 46 is coupled in a rotationally fixed manner to a wheel rim 58 which is arranged radially outside of the wheel carrier 46. The wheel carrier 46 is arranged directly adjacent to the wheel rim 58. In addition, the drive unit 18 is at least completely arranged in the wheel carrier 46.

A detailed view of a part of the brake unit 22 of the exemplary embodiment shown in FIG. 3a can be found in FIG. 3b. It can be seen therein that the brake unit 22 is a spring-loaded brake 60 comprising a first friction partner 62 and a second friction partner 64, the first friction partner 62 being arranged on the brake shaft 40 of the brake unit 22 in a rotationally fixed manner. The brake unit preferably has exactly one brake shaft. The second friction partner 64 is firmly coupled to the vehicle comprising the drive system 10, for example to a frame component 66. During a braking process, the first friction partner 62 and the second friction partner 64 are pressed axially against each other and thus brought into frictional contact. For this purpose, the first friction partner 62 is arranged so as to be axially movable relative to the brake shaft 40. The spring-loaded brake 60 is preferably designed such that it is closed in the unactuated state. By energizing, the spring pressure brake 60 can be released and the drive system 10 can thus be brought into an unbraked state. As can be seen from a gap 68, this state is shown in FIGS. 3a and 3b.

The drive system 10 can have a plurality of brake units 22 in accordance with the arrangement shown in FIG. 3a, the pinion axles 38 of which are arranged on a circular path around the ring gear axle 35. A brake interface 24 can be arranged between each of the pinions 36 of the brake units 22 and the ring gear 34. The drive system 10 particularly preferably comprises exactly two of the brake units 22.

### LIST OF REFERENCE NUMERALS

1 Motor
2 Drive transmission
3 Brake
4 Impeller
10 Drive system
12 Driven unit
14 Electric motor
16 Drive transmission
18 Drive unit
20 Drive interface
22 Brake unit
24 Brake interface
26 Impeller
28 Transmission stage
30 Driven-side transmission component
32 Brake-side transmission component
34 Ring gear
35 Ring gear axle
36 Pinion
38 Pinion axle
40 Brake shaft
42 Wheel end face
44 Inner wheel surface
45 Outer wheel surface
46 Wheel carrier
48 First wheel carrier part
50 Second wheel carrier part
52 Driven-side component
54 Bore
56 Drive transmission output
58 Wheel rim
60 Spring-loaded brake
62 First friction partner
64 Second friction partner
66 Frame component
68 Gap

1. A drive system (10), in particular for a vehicle, comprising
a driven unit (12),
a drive unit (18) for driving the driven unit (12),
a drive interface (20) by means of which the driven unit (12) can be coupled to the drive unit (18),
at least one brake unit (22) for braking the driven unit (12), and
at least one brake interface (24) which is different from the drive interface (20) and by means of which the driven unit (12) can be coupled to the at least one brake unit (22),
wherein the at least one brake interface (24) has a transmission stage (28) with a driven-side transmission component (30) arranged on the driven unit (12) and a brake-side transmission component (32) arranged on the at least one brake unit (22).

2. The drive system according to claim 1, characterized in that each of the at least one brake interface (24) has exactly one transmission stage (28).

3. The drive system according to claim 1, characterized in that the driven-side transmission component (30) is designed as an internally toothed ring gear (34).

4. The drive system according to claim 1, characterized in that the brake-side transmission component (32) is an externally toothed pinion (36).

5. The drive system according to claim 4, characterized in that the pinion (36) is arranged on a brake shaft (40) of the brake unit (22).

6. The drive system according to claim 1, characterized in that a drive-side component of the drive interface (20) is arranged, preferably directly, on the drive unit (18) and/or a driven-side component (52) of the drive interface (20) is arranged, preferably directly, on the driven unit (12).

7. The drive system according to claim 1, characterized in that the driven unit (12) is a wheel, in particular an impeller (26).

8. The drive system according to claim 7, characterized in that the wheel has a, preferably funnel-shaped, wheel carrier (46), comprising a first wheel carrier part (48) and a second wheel carrier part (50), the driven-side transmission component (30) being arranged on the second wheel carrier part (50).

9. The drive system according to claim 8, characterized in that the second wheel carrier part (50) is detachably arranged on the first wheel carrier part (48) or the wheel carrier (46) is a single piece.

10. The drive system according to claim 7, characterized in that the first wheel carrier part (48) has a driven-side component (52) of the drive interface (20).

11. The drive system according to claim 7, characterized in that the wheel carrier (46) is coupled in a rotationally fixed manner to a wheel rim (58) which is arranged radially outside the wheel carrier (46).

12. The drive system according to claim 7, characterized in that the drive unit (18) is arranged at least partially, preferably Page 3 of 3 completely, in the wheel carrier (46).

13. The drive system according to claim 1, characterized in that the brake unit (22) is a spring-loaded brake (60) with a first friction partner (62) and a second friction partner (64), the first friction partner (62) being arranged in a rotationally fixed manner on a brake shaft (40) of the brake unit (22).

14. The drive system according to claim 1, characterized in that the at least one brake unit (22) comprises a plurality of brake units (22), in particular two brake units (22), and the drive system (10) has a corresponding number of brake interfaces (24).

15. The drive system according to claim 14, characterized in that the brake-side transmission component (32) of each of the brake units (22) can be coupled to the same driven-side transmission component (30).

16. A vehicle, in particular an industrial truck, comprising a drive system (10) according to claim 1.
